(19) United States
(12) Patent Application Publication
(10) Pub. No.: US 2007/0121804 A1
(43) Pub. Date: May 31, 2007

(54) Phone voice receiving /playing device

(75) Inventor: Mei-Lin Peng, Hsin-Chu City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: ARTDIO COMPANY INC.

(21) Appl. No.: 11/320,926

(22) Filed: Dec. 30, 2005

(30) Foreign Application Priority Data
Nov. 15, 2005 (TW) 094219743

(51) Int. Cl. H04M 1/64

(52) U.S. Cl. 379/67.1

(57) ABSTRACT

A phone voice receiving/playing device includes a casing, a printed circuit board, an interface connector, an interface medium chip set, a medium enhanced chip set, a medium playing device, and a voice input device. If a software program of a computer system detects an incoming call signal of a web phone, the software program controls the interface medium chip set to convert an interface serial signal and a medium signal. After the medium signal is processed by the medium enhanced chip set, the medium signal is outputted from the medium playing device. The medium signal inputted by the voice input device can be sent to the computer system by a reverse process. The phone voice receiving/playing device also has a phone receiving/transmitting interface, and the phone receiving/transmitting interface is connected to an external phone or a mobile phone for making a call.

### BACKGROUND OF THE INVENTION

1. Field of the Invention

The present invention relates to a multimedia playing/recording device, and more particularly to a multimedia playing/recording device that can play digital multimedia data provided by a computer at regular time. If there in an incoming call from a web phone, the button on the device can be pressed to control and receive the call from the web phone, and a software program is used to control and automatically switch the device into a telephone. Further, the present invention also includes a phone receiving/transmitting interface which can be connected to a phone or a mobile phone for making and receiving calls from the phone voice playing/recording device.

2. Description of the Related Art

A web phone allows users to make a call to any place around the world within a few minutes, and most importantly the cost for such call is very low or even free of charge. Therefore, the web phone becomes very popular after the web phone and its application software such as Skype MSN, or other softphone are introduced. For example, Skype uses a softphone caller having a very good voice quality, and adopts an end-to-end encryption. Furthermore, Skype also allows voice conference of many parties to satisfy the requirements of multinational enterprises.

In general, a set of earphone and microphone is required for using a softphone. The set of earphone and microphone is inserted separately into a microphone socket and a speaker output socket of a computer. Therefore, the web phone can be used with the control of the softphone. However, the foregoing application does not allow its use simultaneously for many parties (such as a conversation between family members and friends at a remote end) since the earphone and microphone set is provided for the use of one person and hanged on the user's body. Furthermore, the user's movement will be limited as well.

Therefore, a phone voice receiving/playing device is needed, such that the device can play digital multimedia data of a computer at regular time. If there is an incoming call from a web phone, a software program controls and automatically switches the phone voice receiving/playing device into a phone for the use of many parties.

### SUMMARY OF THE INVENTION

It is a primary objective of the present invention to provide a phone voice receiving/playing device that can play digital multimedia data of a computer. If there is an incoming call from a web phone, a software program controls and automatically switches the multimedia playing/recording device into a phone for receiving a softphone call.

Another objective of the present invention is to provide a phone voice receiving/playing device, such that if there is an incoming call from a web phone, a speaker will output a voice signal and a microphone will receive and record a voice signal for using the phone voice receiving/playing device by many parties.

A further objective of the present invention is to provide a phone voice receiving/playing device having a phone receiving/transmitting interface, such that the phone receiving/transmitting interface can be connected to an external phone or a mobile phone for making or receiving a call.

To achieve the foregoing objectives, the phone voice receiving/playing device of the invention comprises: a casing having a front casing and a rear casing, and the front casing is engaged with the rear casing, and the front casing has at least one first opening; a printed circuit board installed in the casing for containing the following elements; an interface connector coupled to the printed circuit board by passing a cable through the casing for coupling a computer system; an interface medium chip set coupled to the interface connector; a medium enhanced chip set coupled to the interface medium chip set; a medium playing device coupled to the medium enhanced chip set and exposed from the first opening; and a voice input device coupled to the medium enhanced chip set; such that if a software program of the computer system detects an incoming call signal of a web phone, the software program will control the interface medium chip set to convert an interface serial signal and a medium signal. After the signal is processed by the medium enhanced chip set, the signal is outputted from the medium playing device. Meanwhile, the signal inputted from the voice input device can be sent to the computer system by a reverse process.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic block diagram of a multimedia playing/recording device according to a preferred embodiment of the present invention;

FIG. 2 is a schematic view of connecting a multimedia playing/recording device to a computer and an external microphone according to a preferred embodiment of the present invention;

FIG. 3 is a schematic view of connecting a phone voice receiving/playing device to a mobile phone through the phone receiving/transmitting interface according to a preferred embodiment of the present invention; and

FIG. 4 is a schematic view of connecting a phone voice receiving/playing device to a phone through the phone receiving/transmitting interface according to a preferred embodiment of the present invention.

### DETAILED DESCRIPTION OF THE PREFERRED EMBODIMENTS

The present invention will now be described in more detail hereinafter with reference to the accompanying drawings that show various embodiments of the invention.

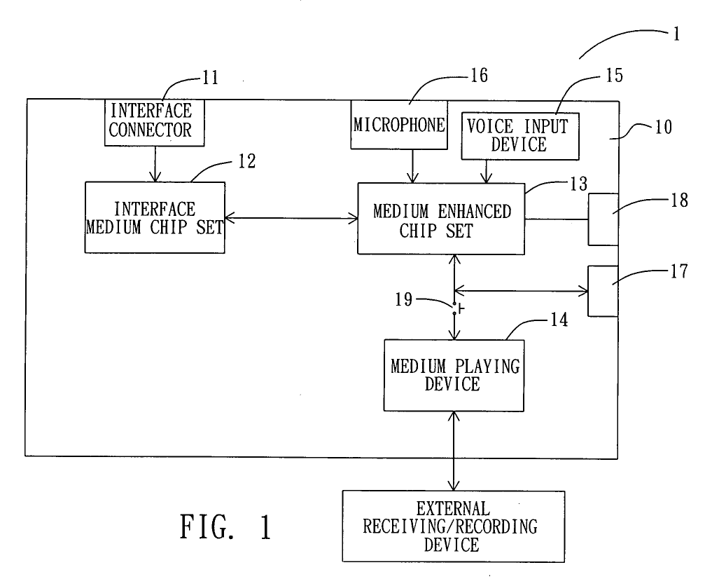

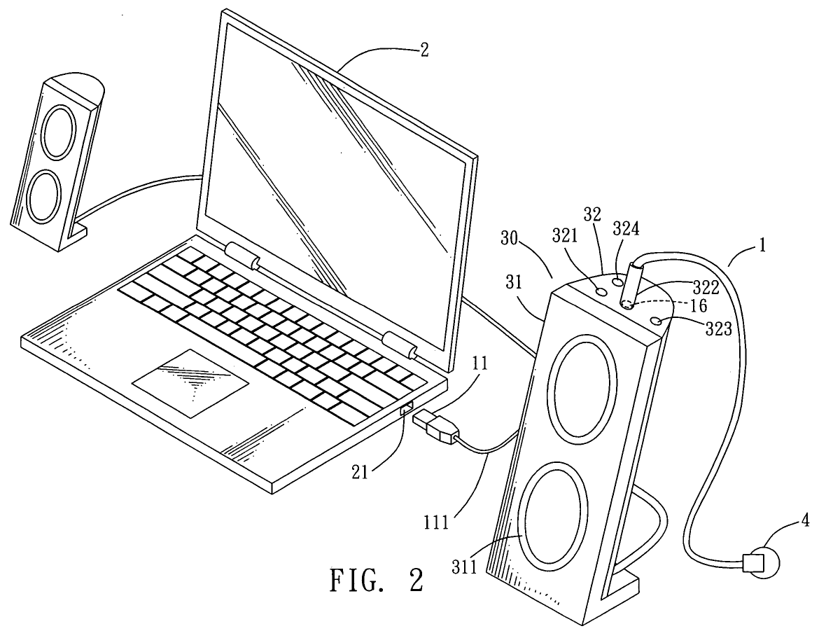

Refer to FIGS. 1 and 2 for the block diagram and the schematic view of a multimedia playing/recording device according to a preferred embodiment of the present invention. In FIG. 1, the phone voice receiving/playing device 1 of the invention comprises a printed circuit board 10, an interface connector 11, an interface medium chip set 12, a medium enhanced chip set 13, a medium playing device 14, a voice input device 15, and a casing 30.

In FIG. 2, the casing 30 has a front casing 31 and a rear casing 32, and the front casing 31 is engaged wit the rear casing 32, and the front casing 31 includes at least one first opening 311 thereon. Further, the rear casing 32 at its top further comprises a second opening 321, a third opening 322, a fourth opening 323, and a fifth opening 324.

In FIG. 1, the printed circuit board 10 is installed in the casing 20 for containing the components such as the interface medium chip set 12, medium enhanced chip set 13, medium playing device 14, and voice input device 15.

The interface connector 11 is coupled to the printed circuit board 10 by passing a cable 111 through the casing 30, and preferably comes with a digital serial signal USB or IEEE1394 interface plug for coupling a USB or IEEE1394 port 21 of a computer system 2 (a shown in FIG. 2).

The interface medium chip set 12 is coupled to the interface connector 11 and further comprises a digital serial signal USB or IEEE1394 interface for processing an interface serial signal of the interface connector 11. The interface medium chip set 12 can execute the conversion between the interface serial signal and a medium signal, and the medium signal can be sent to the medium enhanced chip set 13 for processing.

The medium enhanced chip set 13 is coupled to the interface medium chip set 12 and capable of executing an echo cancel, a volume control, and a surrounding process for the medium signal outputted from the interface medium chip set 12, and then the medium signal is outputted from the medium playing device 14.

The medium playing device 14 is coupled to the medium enhanced chip set 13 and exposed from the first opening 311, and preferably comes with a speaker, so that several parties can listen to the content of the voice signal of the web phone through the speaker. The phone voice receiving/playing device 1 of the invention further comprises an external speaker socket 18 coupled to the medium enhanced chip set 13 and exposed from the second opening 321. If an external speaker (not shown in the figure) is plugged into the external speaker socket 18, the speaker 14 will be disabled to improve the voice effect of listening to the multimedia signals.

The voice input device 15 is coupled to the medium enhanced chip set 14, and preferably comes with a built-in microphone exposed from the casing 30, so that users can input voice signals. After the voice signal is processed (such as an echo cancel, a volume control, or a surrounding process) by the medium enhanced chip set 13, the voice signal is sent to the interface medium chip set 12 and converted into the interface serial signal, which is outputted to the computer system 2. To provide a better voice receiving effect, the present invention further comprises a microphone socket 16 coupled to the medium enhanced chip set 14 and exposed from the third opening 322. If an external microphone 4 with a better performance (as shown in FIG. 2) is plugged into the microphone socket 16, the built-in microphone 15 will be disabled, and the external microphone with a better performance will provide a better voice quality for a phone conversation of many parties.

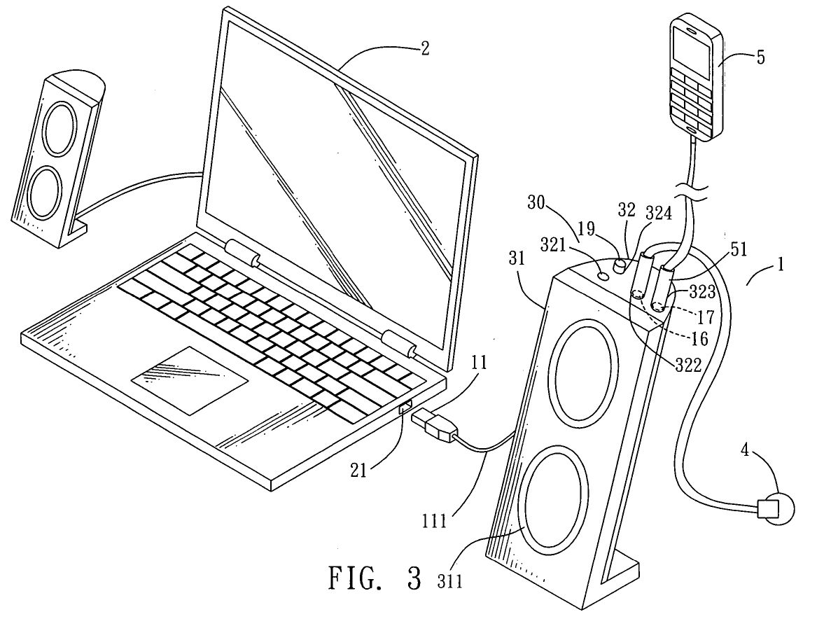

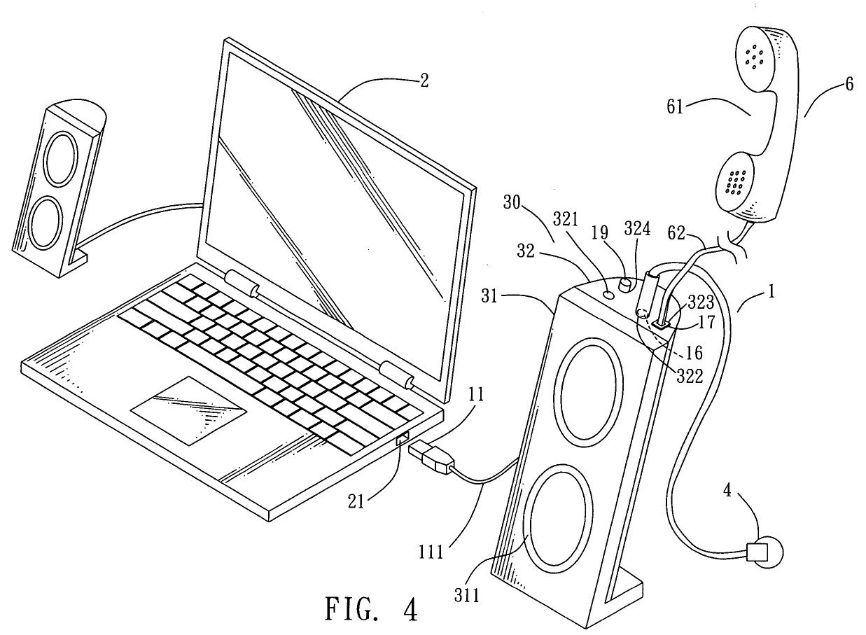

In addition, the phone voice receiving/playing device of the invention further comprises a phone receiving/transmitting interface 17 installed on the printed circuit board 10 and coupled to the medium enhanced chip set 13 and exposed from the fourth opening 323 for plugging in a phone to receive/transmit voice signals. The phone receiving/transmitting interface 17 is a microphone socket or a RJ-11 socket for plugging an earphone microphone 51 (as shown in FIG. 3) of a mobile phone 5 or a receiver 61 (as shown in FIG. 4) of a phone, such that the mobile phone or phone can make or receive a call through the microphone socket. Further, the phone receiving/transmitting interface 17 is controlled by a software program or hardware to receive/transmit voice signals. The software program includes but not limited to the Skype program, MSN program, or other softphone program, and the hardware is a button 19 which is exposed from the fifth opening 324.

Referring to FIG. 2 for the schematic view of connecting a phone voice receiving/playing device I with a computer system 2 and an external microphone 4 according to a preferred embodiment of the present invention, the phone voice receiving/playing device 1 is operated together with a computer system 2, and the computer system 2 preferably includes a Skype program, a MSN program, or other softphone program. During the use of the invention, the interface connector 11 is inserted into the USB port 21 of the computer system 2, and an external microphone 4 is plugged into the microphone socket 16. At regular time, the speaker 14 can play digital multimedia data such as music provided by the computer system 2. If the Skype program, MSN program, or other softphone program of the computer system 2 detects an incoming call signal from a softphone (not shown in the figure), the Skype program, MSN program, or other softphone program controls to pause the playback of the music. In the meantime, the interface medium chip set 12 controls and converts the received voice signal from the interface serial signal into the medium signal. The medium signal is outputted from the speaker 14 after being processed by the medium enhanced chip set 13. After a user hears the voice signal from the opposite party, the replied voice signal is inputted from the external microphone 4 to the medium enhanced chip set 13 for processing. After the replied voice signal is processed, the signal is sent to the interface medium chip set 12 for converting the medium signal into the interface serial signal, and then the signal is sent from the interface connector 11 to the computer system 2. Therefore, the phone voice receiving/playing device 1 of the present invention definitely can overcome the shortcomings of the earphone and microphone set of the prior art softphone.

Referring to FIG. 3 for the schematic view of connecting a phone voice receiving/playing device 1 with a mobile phone through the phone receiving/transmitting interface 17 according to a preferred embodiment of the present invention, the phone voice receiving/playing device 1 also can plug the earphone microphone 51 of the mobile phone 5 into the phone receiving/transmitting interface 17, and the interface connector 11 is plugged into the USB port 21 of the computer system 2, and then an external microphone 4 is plugged into the microphone socket 16. At regular time, the speaker 14 can play digital multimedia data such as music provided by the computer system 2. If the Skype program, MSN program or softphone program of the computer system 2 detects an incoming call signal of a softphone (not shown in the figure) or the button 19 is pressed, the Skype program, MSN program, or other softphone program or the button 19 will control and pause the playback of the music. In the meantime, the interface medium chip set 12 converts the received voice signal from the interface serial signal into the medium signal. The received signal is processed by the medium enhanced chip set 13 and outputted from the phone receiving/transmitting interface 17 to the mobile phone 5. After a user hears the voice signal of the opposite party, the replied voice signal can be inputted from the earphone microphone 51 to the medium enhanced chip set 13 for processing. The replied signal is processed and then sent to the interface medium chip set 12 for converting the medium signal into the interface serial signal, and the interface serial signal is sent from the interface connector 11 to the computer system 2.

Referring to FIG. 4 for the schematic view of connecting a phone voice receiving/playing device 1 with a phone by the phone receiving/transmitting interface 17 according to a preferred embodiment of the present invention, the phone voice receiving/playing device 1 also can plug the receiver 61 of the phone into the phone receiving/transmitting interface 17 through a telephone line 62, and the interface connector 11 is inserted into the USB port 21 of the computer system 2, and then an external microphone 4 is plugged into the microphone socket 16. At regular time, the speaker 14 can play digital multimedia data such as music provided by the computer system 2. If the Skype program, MSN program, or other softphone program of the computer system 2 detects an incoming call signal of a softphone (not shown in the figure) or the button 19 is pressed, the Skype program, MSN program or other softphone program or the button 19 will control and pause the playback of the music. In the meantime, the interface medium chip set 12 controls and converts the received voice signal from the interface serial signal into the medium signal. After the signal is processed by the medium enhanced chip set 13, the signal is outputted from the phone receiving/transmitting interface 17 to the receiver 61 of the phone. After the user hears the voice signal of the opposite party, the replied voice signal can be inputted from the receiver 61 to the medium enhanced chip set 13 for processing. After the replied signal is processed, the signal will be sent to the interface medium chip set 12 to execute the conversion from the medium signal into the interface serial signal, and then the signal is sent from the interface connector 11 to the computer system 2.

With the practice of the present invention, the phone voice receiving/playing device can play digital multimedia data provided by the computer at regular time. If there is an incoming call from a softphone, a software program controls and automatically switches the device into a phone having a phone receiving/transmitting interface. The phone receiving/transmitting interface can be connected to an external phone or a mobile phone for making or receiving a call for the use of many parties. The present invention definitely can overcome the shortcomings of the prior art.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A phone voice receiving/playing device, comprising:
a casing, having a front casing and a rear casing, and said front casing being engaged with said rear casing, and said front casing having at least one first opening;
a printed circuit board, installed in said casing for containing the following elements;
an interface connector, coupled to said printed circuit board by passing a cable through said casing for coupling to a computer system;
an interface medium chip set, coupled to said interface connector;
a medium enhanced chip set, coupled to said interface medium chip set;
a medium playing device, coupled to said medium enhanced chip set and exposed from said first opening; and
a voice input device, coupled to said medium enhanced chip set;
such that if a software program of said computer system detects an incoming call signal of a softphone, said software program controls said interface medium chip set to execute a conversion between an interface serial signal and a medium signal, and said medium signal is outputted from said medium playing device after said medium signal is processed by said medium enhanced chip set.

2. The phone voice receiving/playing device of claim 1, wherein said interface connector is a digital serial signal USB or an IEEE1394 interface plug, and said interface serial signal is a digital serial signal USB or an IEEE1394 interface serial signal.

3. The multimedia playing/recording device of claim 1, wherein said interface medium chip set further comprises a digital serial signal USB or an IEEE1394 interface for facilitating the processing of said interface serial signal.

4. The phone voice receiving/playing device of claim 1, wherein said medium enhanced chip set further comprises an echo cancel, a volume control, and a surrounding process function.

5. The phone voice receiving/playing device of claim 1, wherein said medium playing device is a speaker.

6. The phone voice receiving/playing device of claim 5, wherein said rear casing at its top further comprises a second opening.

7. The phone voice receiving/playing device of claim 6, further comprising an external speaker socket coupled to said medium enhanced chip set and exposed from said second opening, such that if an external speaker is plugged into the external speaker socket, said speaker will be disabled.

8. The phone voice receiving/playing device of claim 1, wherein said voice input device is a built-in microphone.

9. The phone voice receiving/playing device of claim 8, wherein said rear casing at its top further comprises a third opening and a fourth opening.

10. The phone voice receiving/playing device of claim 9, further comprising a microphone socket coupled to said medium enhanced chip set and exposed from said third opening, such that if an external microphone is plugged into said microphone socket, said built-in microphone will be disabled.

11. The phone voice receiving/playing device of claim 1, wherein said software program is a Skype program, a MSN program, or other softphone program.

12. The phone voice receiving/playing device of claim 8, further comprising a phone receiving/transmitting interface disposed on said printed circuit board and coupled to said medium enhanced chip set and exposed from said fourth opening for plugging in a phone for receiving/transmitting a voice signal.

13. The phone voice receiving/playing device of claim 12, wherein said phone receiving/transmitting interface is a microphone socket for plugging in an earphone and a microphone of a mobile phone, so that said mobile phone can make or receive a call through said microphone socket.

14. The phone voice receiving/playing device of claim 12, wherein said phone receiving/transmitting interface is a RJ-11 socket for plugging a receiver of a phone, so that said phone can make or receive a call through said RJ-11 socket.

15. The phone voice receiving/playing device of claim 12, wherein said hone receiving/transmitting interface uses the control of a hardware control or the detection of said software program to drive said phone receiving/transmitting interface for receiving/transmitting a voice signal.

16. The phone voice receiving/playing device of claim 15, wherein said hardware is a button, and said button is exposed from said fourth opening.
